(19) United States
(12) Patent Application Publication
(10) Pub. No.: US 2006/0257285 A1
(43) Pub. Date: Nov. 16, 2006

(54) Colormetric imaging array device

(76) Inventors: Jeremy W. Burdon, Minneapolis, MN (US); Manuel Oliver, Scottsdale, AZ (US); Peter C. Roberts, Sun Valley, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/966,755

(22) Filed: Oct. 14, 2004

Related U.S. Application Data
(60) Provisional application No. 60/511,488, filed on Oct. 14, 2003.

(51) Int. Cl. G01N 31/22; G01N 21/00

(52) U.S. Cl. 422/56

(57) ABSTRACT

An apparatus is provided for detecting an atmospheric component. The apparatus comprises one or more arrays, wherein each array comprises one or more colorimetric reagents. A material encapsulating the colorimetric reagents of each array is capable of being at least partially removed to expose the colorimetric reagents of a selected array to the atmosphere. An imager detects colors of the one or more colorimetric reagents in the selected array. Circuitry then determines changes in colors of the one or more colorimetric reagents within the selected array.

### CROSS-REFERENCE TO RELATED APPLICATIONS

This application claims the benefit of U.S. Application No. 60/511,488, filed 14 Oct. 2003.

### FIELD OF INVENTION

The present invention generally relates to a device for determining the presence of an atmospheric component and more particularly relates to a device for alerting the device user and others of the presence of an unwanted environmental agent.

### BACKGROUND OF THE INVENTION

First responders, such as fire fighters, police, or HAZMAT personnel, many times arrive at the site of an emergency situation without the ability to detect environmental hazards such as toxic industrial chemicals, chemical warfare agents, or radiation. Such inability may result in physical harm to the first responders and other responders that follow. Large quantities of toxic industrial chemicals may be present ‘normally’ in populated areas: industrial sites, storage depots; transportation and distribution facilities, resulting in the potential for accidents such as the accidental release of methylisocyanate in Bhopal, India in 1984. Other toxic industrial chemicals, for example, include ammonia, chlorine, hydrogen chloride, and sulfuric acid. Chemical warfare agents are usually more lethal than toxic industrial chemicals. Nerve agents are the most common chemical warfare agents, such as the nerve agent Sarin that was used in the 1995 Tokyo subway gas attack. Other chemical warfare agents, for example, include Tabun, sulfur mustard, and hydrogen cyanide.

Chemical warfare agents typically are medium to high volatility and therefore may be detected in the gas phase. Electronic monitors for chemical warfare agents are based on electronic detection using ion-mobility-spectrometry, photo-ionization, and flame-ionization. These tools offer a broadband response with high levels of sensitivity, but most suffer from interference effects caused by what is often a highly complex chemical background mix at the scene, and most commercial tools exhibit high false-positive responses to contaminants. Furthermore, these devices are not designed to be wearable, and most tools, although handheld, are relatively bulky and fully engage the user detracting from other important duties.

Known colorimetric methods for detecting such chemical and biological hazards include simple color-change badges generally have a limited life span, e.g., 8 hours, to tubes providing quantitative data with high specificity, but both require the user to assess the color change to determine the hazard level. Furthermore, gas tubes are sensitive to physical abuse and are limited in some cases to only one and in other cases only a few hazards requiring the user to know what type or types of hazards are suspected.

Radiological threats have become more relevant with the so-called ‘dirty bomb’, which combines explosive blast with surreptitious ‘ingredients’ of radionuclides such as Cs-137, a beta and gamma emitter. Radiological monitors (dosimeters) have been available for many years, mostly for occupational safety monitoring.

Pager style, wearable units, having audio/visual alerts built-in are available for such monitoring. Also, a variety of miniature radiation detectors exist, such as small Geiger-Muller tubes, selective scintillation layers with photo-sensors, and silicon diodes. Probes can be attached to other types of monitors, covering any of the radiation species, but these monitors are at best hand-held, and must be maintained regularly. Recently, colorimetric badges that detect radiation have been developed; however, these require the user to constantly monitor its status.

Accordingly, it is desirable to provide a low cost, low power, miniaturized (wearable), reliable (having fewer negatives and false positives) apparatus for detecting the presence of environmental agents and transmitting the results to the user and others without disrupting the user's duties.

### BRIEF SUMMARY OF THE INVENTION

An apparatus is provided for detecting an atmospheric component. The apparatus comprises one or more arrays, wherein each array comprises one or more colorimetric reagents. A material encapsulating the colorimetric reagents of each array is capable of being at least partially removed to expose the colorimetric reagents of a selected array to the atmosphere. An imager detects colors of the one or more colorimetric reagents in the selected array. Circuitry then determines changes in colors of the one or more colorimetric reagents within the selected array

### BRIEF DESCRIPTION OF THE DRAWINGS

The present invention will hereinafter be described in conjunction with the following drawing figures, wherein like numerals denote like elements, and

FIGS. 1-5 illustrate a cross sectional view of four embodiments of colorimetric reagents;

FIG. 6 illustrates a top view of colorimetric reagents in an array;

FIG. 7 illustrates a top view of a group of colorimetric reagent arrays;

FIG. 8 illustrates a block diagram of a system including the array of colorimetric reagents;

FIG. 9 illustrates a top view of an array of colorimetric reagents in yet another embodiment of the present invention.

### DETAILED DESCRIPTION OF EXEMPLARY EMBODIMENTS

The following detailed description of the invention is merely exemplary in nature and is not intended to limit the invention or the application and uses of the invention. Furthermore, there is no intention to be bound by any theory presented in the preceding background of the invention or the following detailed description of the invention.

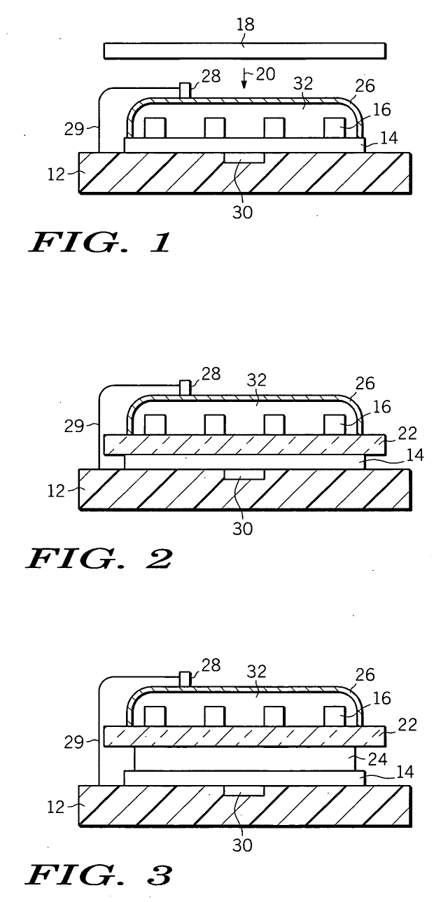

Referring to FIG. 1, an imager 14 is positioned between a base 12 and colorimetric reagents 16. The base 12 may comprise packaging, an integrated circuit board, or a semiconductor material and may include interface circuitry, a processor, etc., in a manner known to those skilled in the art. The imager 14 may comprise, for example, charge coupled devices which are basically storage and conversion devices capable of changing incoming photons into a voltage.

The colorimetric reagents 16 comprise a thin layer of a chemical that maintains a certain color in ambient air, but changes color when subjected to a specific gaseous agent. Examples of chemicals that could be used as colorimetric reagents include the following:

For the testing for carbon monoxide (CO), the colorimetric reagent 16 comprising K₂ Pd (SO₃)₂ would turn from yellow to black in accordance with the equation:
CO+K₂ Pd (SO₃)₂ yields K₂ (SO₃)₂ Pd CO, where K₂ (SO₃) Pd CO yields CO₂+SO₂+Pd+K₂SO₃.

For the testing for ammonia (NH₃), the colorimetric reagent 16 comprising H₃PO₄ would turn from blue to pink in accordance with the equation:
2NH₃+H₃PO₄ yields (NH₄)₂ PO₄.

For the testing for hydrogen sulfide (H₂S), the colorimetric reagent 16 comprising Ag would turn from white-gray to black in accordance with the equation
H₂S+Ag yields AgS.

For the testing for organic matter (RCH₂OH), the colorimetric reagent 16 comprising KMNO₄ would turn from purple to brown in accordance with the equation:
RCH₂OH+KMNO₄ yields RCOO—K++MNO₂+KOH.

Another test for organic matter, the colorimetric reagent 16 comprising Cr₂O₇ would turn from orange-red to green in accordance with the equation:
RCH₂OH+Cr₂O₇ yields RCHO+Cr₃.

For the testing for inorganic matter, such as a Hydrogen Chloride (HCL) mist, the ph indicators Bromophenol blue would change from red to blue, and Mehtylene orange would change from orange to green.

A light source 18 optionally is provided for directing light 20 onto the colorimetric reagents. The light source provides a known spectrum that results in a more reliable determination of the colors of the colorimetric reagents than is provided by ambient light.

The colorimetric reagents 16 are encapsulated in a material 26, e.g., glass, plastic, and low melting-point metals) that may have a portion selectively removed to create an opening 27 by, for example, a heater 28 (see FIG. 5). The heater 28 is coupled electrically to the base 12 by electrical connection 29. In another embodiment, the material 26 may be mechanically removed by, for example, punctuating or peeling off a protective cover. As an unwanted environmental agent in introduced, it would flow through opening 27 into cavity 32 and onto the colorimetric reagents 16.

A heater 30 is positioned so as to prevent the temperature from dropping to an extent that would prevent the chemical reaction in the colorimetric reagents 16 from occurring.

FIGS. 2-4 illustrate alternative embodiments of the invention. In FIG. 2, a transparent layer 22 is positioned between the colorimetric reagents 16 and the imager 14. In FIG. 3, a spacer 24 is positioned between the transparent layer 22 and the imager 14. The transparent layer 22 would allow for easy removal of the colorimetric reagents 16 permitting reuse of the imager 14 and base 12.

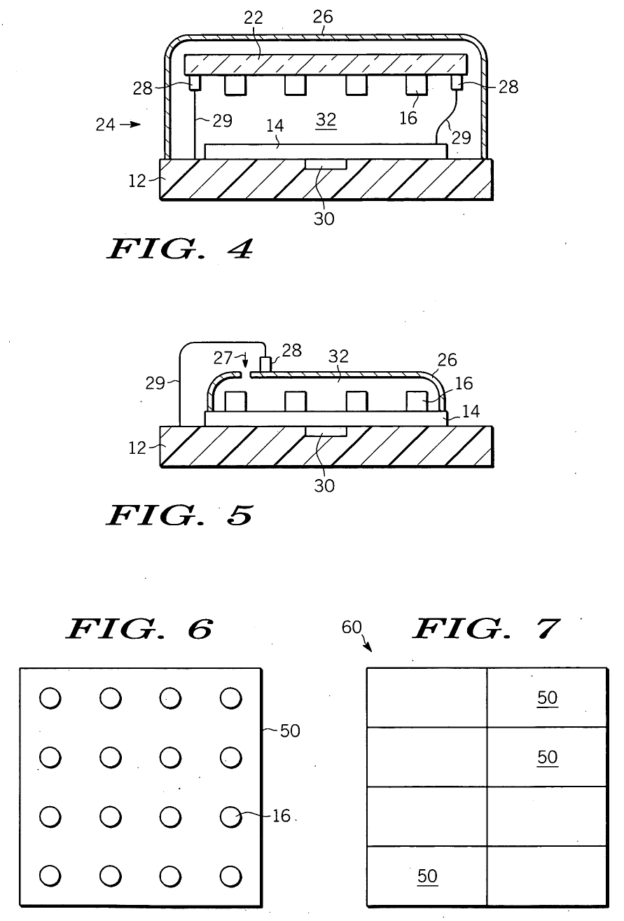

In FIG. 4, the spacer 24 is positioned between the imager 14 and the colorimetric reagents 16, with the transparent layer 22 positioned on the opposed side of the colorimetric reagents 16. In this case, the environmental gas to be detected would flow through the spacer 24 and around the colorimetric reagents between the transparent layer 22 and the imager 14. Another embodiment might include a lens positioned between the colorimetric reagents 16 and the imager 14 for focusing the light reflecting from the colorimetric reagents 16.

Referring to FIG. 6, an array 50 comprises a plurality of colorimetric reagents 16. Although a 4×4 array is shown, any number of the colorimetric reagents 16, it is understood that the array 50 could comprise one or more of the colorimetric reagents 16 may be utilized. An array 50 with multiple colorimetric reagents 16 of the same type provides redundancy. If the chemical in one colorimetric reagent 16 malfunctions, the other colorimetric reagents 16 would still provide an accurate reading. Furthermore, the colorimetric reagents 16 could be of various types, thus providing the ability to simultaneously test for a number of unwanted environmental agents at the same time.

Referring to FIG. 7, an apparatus 60 includes a number of arrays 50. Although a 3×3 array is shown, it should be understood that any number of arrays could be included, such as 1×2, 1×3, 3×3, or much larger. The use of multiple arrays 50 allows for the use of one array at a time. The use of a second array could be used to confirm a reading from the first array, or the second array could be used on a second day, the third array on a third day, and so forth.

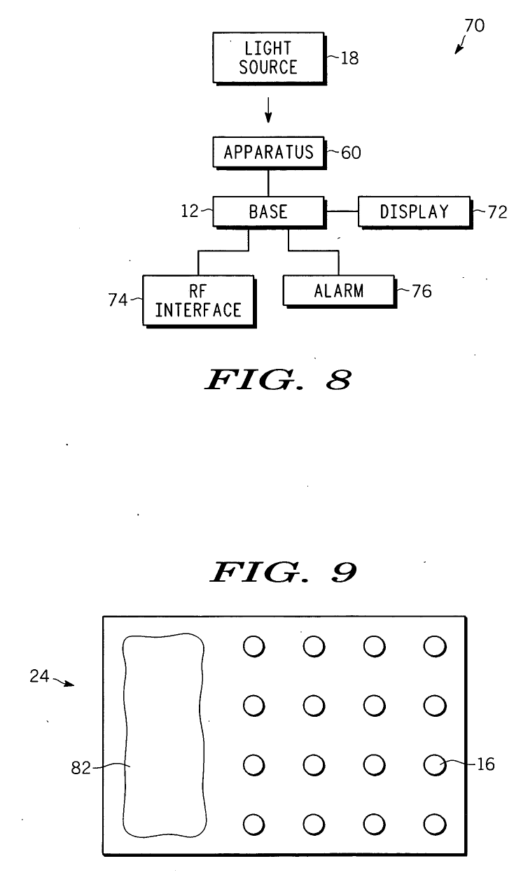

Referring to FIG. 8, the colorimetric imaging array device 70 includes apparatus 60 coupled to base 12 which includes interface circuitry and processor. The base 12 may be coupled to a display 72 for visually displaying information provided from the processor, an RF interface 74 for transmitting the information to others, and an alarm 76 that would audibly and/or visually alert the user. The processor and RF interface 74 may also include circuitry for providing GPS information.

One drawback experienced with the use of colorimetric reagents 16 is interference of a second gas in the presence of the unwanted gas that may cause the colorimetric reagents 16 to give a false reading. Referring to FIG. 9, a substance 82 is positioned in the flow of the unwanted gases prior to the gases reaching the colorimetric reagents 16. The substance 82 would absorb the second gas so as to allow the colorimetric reagents 16 to “see” only the unwanted gas. Examples of the substance 82 include activated carbon (C(Ac)) to remove organic species, such as H₂S, for the detection of inorganic gases, such as CO and HCL; and SiO₂ dessicant to remove H₂O. The substance 82 could also be used to remove humidity, or other obstacles to the colorimetric reagents 16 giving a proper reading.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An apparatus for detecting an atmospheric component, comprising:
one or more arrays, each array comprising two or more of colorimetric reagents;
a material encapsulating the colorimetric reagents of each array, and capable of being at least partially removed to expose the colorimetric reagents of a selected array to the atmosphere;
an imager for detecting colors of the two or more colorimetric reagents in the selected array; and
circuitry coupled to the imager for determining changes in colors of the two or more colorimetric reagents within the selected array when exposed to the atmosphere.

2. The apparatus according to claim 1 wherein the device comprises a heater on each of the one or more arrays that may be activated to remove at least a portion of the material on the selected array.

3. The apparatus according to claim 1 wherein the one or more colorimetric reagents within each array comprise at least two colorimetric reagents of a first colorimetric reagent and at least two colorimetric reagents of a second colorimetric reagent.

4. The apparatus according to claim 3 wherein the second colorimetric reagents reduce the possibility of the first colorimetric reagent from changing colors in response to a first atmospheric component due to the presence of a second atmospheric component.

5. The apparatus according to claim 1 further comprising a light source for lighting the colorimetric reagents.

6. The apparatus according to claim 1 wherein the apparatus comprises one of a cell phone and a two-way radio.

7. The apparatus according to claim 1 a wireless link for providing information regarding the changes in colors to a computer system.

8. The apparatus according to claim 1 further comprising a integral heater to improve reactivity of the colorimetric reagents at low ambient temperatures.

9. The apparatus according to claim 1 wherein the apparatus is one of a plurality that are coupled wirelessly with a computer terminal that provides information regarding the unwanted environmental hazards in response to the changes in colors of each apparatus.

10. The apparatus according to claim 9 wherein each apparatus further provides global positioning information to the computer terminal.

11. An apparatus for detecting unwanted environmental hazards, comprising:
one or more arrays, each array comprising two or more of colorimetric reagents, each array having the colorimetric reagents encapsulated in a material;
a device for removing at least a portion of the material from a selected array to expose the colorimetric reagents to the atmosphere;
an imager for detecting colors of the two or more colorimetric reagents in the selected array; and
circuitry responsive to a user of the apparatus for selecting the array, coupled to the imager for determining changes in colors of the two or more colorimetric reagents within the selected array, and alerting the user of any detected unwanted environmental hazard.

12. The apparatus according to claim 11 wherein the device comprises a heater on each of the one or more arrays that may be activated to select the desired array.

13. The apparatus according to claim 11 wherein the one or more colorimetric reagents within each array comprise at least two colorimetric reagents of a first colorimetric reagent and at least two colorimetric reagents of a second colorimetric reagent.

14. The apparatus according to claim 13 wherein the second colorimetric reagents reduce the possibility of the first colorimetric reagent from changing colors in response to a first atmospheric component due to the presence of a second atmospheric component.

15. The apparatus according to claim 11 further comprising a light source for lighting the colorimetric reagents.

16. The apparatus according to claim 11 wherein the apparatus comprises one of a cell phone and a two-way radio.

17. The apparatus according to claim 11 a wireless link for providing information regarding the changes in colors to a computer system.

18. The apparatus according to claim 11 further comprising a integral heater to improve reactivity of the colorimetric reagents at low ambient temperatures.

19. The apparatus according to claim 11 wherein the apparatus is one of a plurality that are coupled wirelessly with a computer terminal that provides information regarding the unwanted environmental hazards in response to the changes in colors of each apparatus.

20. The apparatus according to claim 19 wherein each apparatus further provides global positioning information to the computer terminal.
